(19) United States
(12) Patent Application Publication
(10) Pub. No.: US 2005/0087522 A1
(43) Pub. Date: Apr. 28, 2005

(54) Laser processing of a locally heated target material

(76) Inventors: Yunlong Sun, Beaverton, OR (US); Liu Jinjiao, Beijing (CN); Richard S. Harris, Portland, OR (US); Pradeep Subrahmanyan, Beaverton, OR (US); Robert F. Hainsey, Portland, OR (US); Weixiong Lu, Portland, OR (US)

Correspondence Address: Sandra K. Szczerbicki, Suite 2600, 900 SW Fifth Avenue, Portland, OR, 97204-1268, US

(21) Appl. No.: 10/777,973

(22) Filed: Feb. 11, 2004

Related U.S. Application Data
(60) Provisional application No. 60/514,240, filed on Oct. 24, 2003.

(51) Int. Cl. B23K 26/38

(52) U.S. Cl. 219/121.71; 219/121.69; 219/121.61

(57) ABSTRACT

A method and laser system effect rapid removal of material from a workpiece by applying heating energy in the form of a light beam to a target location on the workpiece to elevate its temperature while maintaining its dimensional stability. When the target portion of the workpiece is heated, a laser beam is directed for incidence on the heated target location. The laser beam preferably has a processing laser output that is appropriate to effect removal of the target material from the workpiece. The combined incidence of the processing laser output and the heating energy on the target location enables the processing laser output to remove a portion of the target material at a material removal rate that is higher than the material removal rate achievable when the target material is not heated.

### RELATED APPLICATIONS

This application claims the benefit under 35 U.S.C. § 119(c) of U.S. Provisional Patent Application No. 60/514,240, filed Oct. 24, 2003.

### TECHNICAL FIELD

The present invention relates to laser processing a locally heated workpiece and, in particular, to a system and method that elevate the temperature of a target location on the workpiece to effect an increase in target material removal rate and workpiece throughput rate.

### BACKGROUND OF THE INVENTION

Laser processing can be conducted on numerous different workpieces using various lasers effecting a variety of processes. The specific types of laser processing of interest with regard to the present invention are laser processing of a single or multilayer workpiece to effect hole and/or via formation and laser processing of a semiconductor wafer to effect wafer dicing.

Regarding laser processing via and/or holes in a multilayer workpiece, U.S. Pat. Nos. 5,593,606 and 5,841,099 of Owen et al. describe methods of operating an ultraviolet (UV) laser system to generate laser output pulses characterized by pulse parameters set to form in a multilayer device through-hole or blind vias in two or more layers of different material types. The laser system includes a nonexcimer laser that emits, at pulse repetition rates of greater than 200 Hz, laser output pulses having temporal pulse widths of less than 100 ns, spot areas having diameters of less than 100 μm, and average intensities or irradiance of greater than 100 mW over the spot area. The preferred nonexcimer UV laser identified is a diode-pumped, solid-state (DPSS) laser.

Published U.S. Patent Application No. US/2002/0185474 of Dunsky et al. describes a method of operating a pulsed CO₂ laser system to generate laser output pulses that form blind vias in a dielectric layer of a multilayer device. The laser system emits, at pulse repetition rates of greater than 200 Hz, laser output pulses having temporal pulse widths of less than 200 ns and spot areas having diameters of between 50 μm and 300 μm.

Laser ablation of a target material, particularly when a UV DPSS laser is used, relies upon directing to the target material a laser output having a fluence or energy density that is greater than the ablation threshold of the target material. A UV laser emits a laser output that can be focused to have a spot size of between about 10 μm and about 30 μm at the 1/e² diameter. In certain instances, this spot size is smaller than the desired via diameter, such as when the desired via diameter is between about 50 μm and 300 μm. The diameter of the spot size can be enlarged to have the same diameter as the desired diameter of the via, but this enlargement reduces the energy density of the laser output such that it is less than the ablation threshold of the target material and cannot effect target material removal. Consequently, the 10 μm to 30 μm focused spot size is used and the focused laser output is typically moved in a spiral, concentric circular, or “trepan” pattern to form a via having the desired diameter. Spiraling, trepanning, and concentric circle processing are types of so-called non-punching via formation processes. For via diameters of about 50 μm or smaller, direct punching delivers a higher via formation throughput.

In contrast, the output of a pulsed CO₂ laser is typically larger than 50 μm and capable of maintaining an energy density sufficient to effect formation of vias having diameters of 50 μm or larger on conventional target materials. Consequently, a punching process is typically employed when using a CO₂ laser to effect via formation. However, a via having a spot area diameter of less than 50 μm cannot be formed using a CO₂ laser.

The high degree of reflectivity of the copper at the CO₂ wavelength makes forming a through-hole via using a CO₂ laser in a copper sheet having a thickness greater than about 5 microns very difficult. Thus CO₂ lasers can typically be used to form through-hole vias only in copper sheets having a thickness that is between about 3 microns and about 5 microns or that have been surface treated to enhance the absorption of the CO₂ laser energy.

The most common materials used in making multilayer structures for printed circuit board (PCB) and electronic packaging devices in which vias are formed typically include metals (e.g., copper) and dielectric materials (e.g., polymer polyimide, resin, or FR-4). Laser energy at UV wavelengths exhibits good coupling efficiency with metals and dielectric materials, so the UV laser can readily effect via formation on both copper sheets and dielectric materials. Also, UV laser processing of polymer materials is widely considered to be a combined photo-chemical and photo-thermal process, in which the UV laser output partially ablates the polymer material by disassociating its molecular bonds through a photon-excited chemical reaction thereby producing superior process quality as compared to the photo-thermal process that occurs when the dielectric materials are exposed to longer laser wavelengths. For these reasons, solid-state UV lasers are preferred laser sources for processing these materials.

CO₂ laser processing of dielectric and metal materials and UV laser processing of metals are primarily photo-thermal processes, in which the dielectric material or metal material absorbs the laser energy, causing the material to increase in temperature, soften or become molten, and eventually ablate, vaporize, or blow away. Ablation rate and via formation throughput, are, for a given type of material, a function of laser energy density (laser energy (J) divided by spot size (cm²)), power density (laser energy (J) divided by spot size (cm²) divided by pulse width (seconds)), laser wavelength, and pulse repetition rate.

Thus laser processing throughput, such as, for example, via formation on PCB or other electronic packaging devices or hole drilling on metals or other materials, is limited by the laser power intensity available and pulse repetition rate, as well as the speed at which the beam positioner can move the laser output in a spiral, concentric circle, or trepan pattern and between via positions. An example of a UV DPSS laser is a Model LWE Q302 (355 nm) sold by Lightwave Electronics, Mountain View, Calif. This laser is used in a Model 5310 laser system or other systems in its series manufactured by Electro-Scientific Industries, Inc., Portland, Oreg., the assignee of the present patent application. The laser is capable of delivering 8 W of UV power at a pulse repetition rate of 30 kHz. The typical via formation throughput of this laser and system is about 600 vias each second on bare resin. An example of a pulsed CO₂ laser is a Model Q3000 (9.3 μm) sold by Coherent-DEOS, Bloomfield, Conn. This laser is used in a Model 5385 laser system or other systems in its series manufactured by Electro-Scientific Industries, Inc. The laser is capable of delivering 18 W of laser power at a pulse repetition rate of 60 kHz. The typical via formation throughput of this laser and system is about 1000 vias each second on bare resin and 250-300 vias each second on FR-4.

Increased via formation throughput could be accomplished by increasing the laser energy per pulse and the pulse repetition rate. However, for the UV DPSS laser and the pulsed CO₂ laser, there are practical problems stemming from the amounts by which the laser energy per pulse and the pulse repetition rate can be increased. Moreover, as laser energy per pulse increases, the risk of damage to the optical components inside and outside the laser resonator increases. Repairing damage to these optical components is especially time-consuming and expensive. Additionally, lasers capable of operating at a high laser energy per pulse or a high pulse repetition rate are often prohibitively expensive.

Regarding dicing a semiconductor wafer, there are two common methods of effecting the dicing: mechanical sawing and laser dicing. Mechanical sawing typically involves using a diamond saw to dice wafers having a thickness greater than about 150 microns to form streets having widths of greater than about 100 microns. Mechanically sawing wafers having a thickness that is less than about 100 microns results in cracking of the wafer.

Laser dicing typically involves dicing the semiconductor wafer using a pulsed IR, green, or UV laser. Laser dicing offers various advantages over mechanically sawing a semiconductor wafer, such as the ability to reduce the width of the street to about 50 microns when using a UV laser, the ability to dice a wafer along a curved trajectory, and the ability to effectively dice thinner silicon wafers than can be diced using mechanical sawing. For example, a silicon wafer having a thickness of about 75 microns may be diced with a DPSS UV laser operated at a power of about 8 W and a repetition rate of about 30 kHz at a dicing speed of 120 mm/sec to form a kerf having a width of about 35 microns. However, one disadvantage of laser dicing semiconductor wafers is the formation of debris and slag, both of which could adhere to the wafer and are difficult to remove. Another disadvantage of laser dicing semiconductor wafers is that the workpiece throughout rate is limited by the power capabilities of the laser.

What is needed, therefore, is a method of and laser system for effecting high-speed laser processing of a workpiece at a high rate of throughput to effect the formation of vias and/or holes using UV, green, IR, and CO₂ lasers and to efficiently and accurately dice semiconductor wafers using UV, green, and IR lasers.

### SUMMARY OF THE INVENTION

An object of the present invention is, therefore, to provide a method of and a laser system for improving the speed and/or efficiency of (1) laser processing via and/or holes in single and multilayer workpieces and (2) dicing semiconductor wafers such that the rates of material removal and workpiece throughput are increased and process quality is improved.

The method and laser system of the present invention effect rapid removal of material from a workpiece. The method of the present invention entails applying heating energy in the form of a light beam to a target location on the workpiece to elevate its temperature while substantially maintaining its dimensional stability. When the target portion of the workpiece is heated, a laser beam is directed for incidence on the heated target location. The laser beam preferably has a processing laser output characterized by a wavelength, a beam spot size, an energy per pulse, a pulse width, and a pulse repetition rate that, in combination, are appropriate to effect removal of the target material from the workpiece. The combined incidence of the processing laser output and the heating energy on the target location enables the processing laser output to remove a portion of the target material at a material removal rate that is higher than the material removal rate achievable when the target material is not heated.

A first preferred embodiment of the present invention involves (1) using one of a diode laser, a diode laser array, an array of light emitting diodes, an IR laser, a fiber laser, a UV laser, a CO₂ laser, or a combination thereof to locally heat the target location, and (2) using one of a UV laser, an IR laser, a green laser, and a CO₂ laser to emit the processing laser output whose incidence on the target material effects removal of target location material to form a hole or via. The via can be either a blind via or a through-hole via. The processing laser output is preferably emitted by a solid-state laser having a wavelength in one of the IR, UV, or green light spectrums. In an alternative preferred implementation, the processing laser output it emitted by a CO₂ laser having a wavelength between about 9.2 microns and about 10.6 microns.

A second preferred embodiment of the present invention involves (1) using one of a diode laser, a diode laser array, a solid-state laser, a fiber laser, an array of light emitting diodes, or a combination thereof to locally heat the target location, and (2) using one of a UV laser, a green laser, or an IR laser to emit the processing laser output whose incidence on the target material effects removal of target location material to dice a semiconductor wafer workpiece. The processing laser output is preferably emitted by a mode-locked or Q-switched solid-state laser having a wavelength between about 200 nm and 1600 nm.

In preferred embodiments, the heating source is in a continuous mode (CW) or a quasi-continuous mode. With its relatively low intensity output, the heating source is used only to heat the material, while the processing laser, with its higher intensity output, accomplishes material removal. For example, when the average power of a pulsed processing laser is 8 W and the heating source delivers 8 W of CW power, the total energy directed at the target material effectively doubles. The consequent workpiece throughput rate increase is estimated to be between about 50% and 100%.

Applying thermal energy to the target material at the target location improves workpiece throughput without adversely affecting the quality of the hole, via, street, or kerf formed. This is so because (1) the heating source heats only the target location, minimizing the formation of a heat affected zone (HAZ) and/or an area of dimensional distortion; and (2) the heating source is used primarily to elevate the temperature of the target material, and ablative removal of the target material is primarily effected by incidence of the processing laser output on the target material. Furthermore, when the temperature of the target material is elevated, its absorption coefficient for a given laser wavelength increases. For example, because a silicon wafer readily absorbs light at a wavelength of 808 nm, directing a diode laser operated at a wavelength of 808 nm for incidence on the target material location of the silicon wafer transfers heating energy from the laser to the target material and thus effectively elevates the temperature of the target material at the target location. This elevation of temperature improves the silicon wafer's absorption of the processing laser output, which may be, for example, emitted by a mode-locked IR laser operated at a wavelength of 1064 nm. Using this process, the mode-locked IR laser can more effectively remove the target material while effecting the desired increase in street or kerf quality.

The formation of a through-hole via on a thin copper sheet using a CO₂ laser provides an additional example. The copper sheet's low absorption of laser energy within the CO₂ wavelength range typically presents a challenge to via formation. By directing for incidence on the target location of the thin copper sheet heating energy having a wavelength that is significantly shorter than the wavelength of the CO₂ laser energy (e.g. the diode laser wavelength of 808 nm), the temperature of the thin copper sheet can effectively be elevated. At this elevated temperature, the coupling of the CO₂ laser energy and the thin copper sheet is improved such that the processing output emitted by the CO₂ laser forms a high-quality via in the thin copper sheet.

Additional objects and advantages of this invention will be apparent from the following detailed description of preferred embodiments thereof, which proceeds with reference to the accompanying drawings.

### BRIEF DESCRIPTION OF THE DRAWINGS

FIGS. 1a and 1b are simplified schematic diagrams of two preferred laser systems that apply thermal energy to, and direct a processing laser output for incidence on, a target material in accordance with the present invention.

FIG. 2 is an enlarged, cross-sectional side view of a multilayer workpiece having a through-hole via and a blind via formed in accordance with the present invention.

FIG. 3 is a schematic diagram of an exemplary laser system of the present invention.

FIGS. 4a and 4b are graphs showing as a function of temperature the absorption coefficients of, respectively, silicon and aluminum.

FIG. 5a shows an example of a processing laser beam output waveform; and FIGS. 5b and 5c show two examples of heating light beam waveforms having, respectively, constant and decreasing power intensities.

### DETAILED DESCRIPTION OF PREFERRED EMBODIMENTS

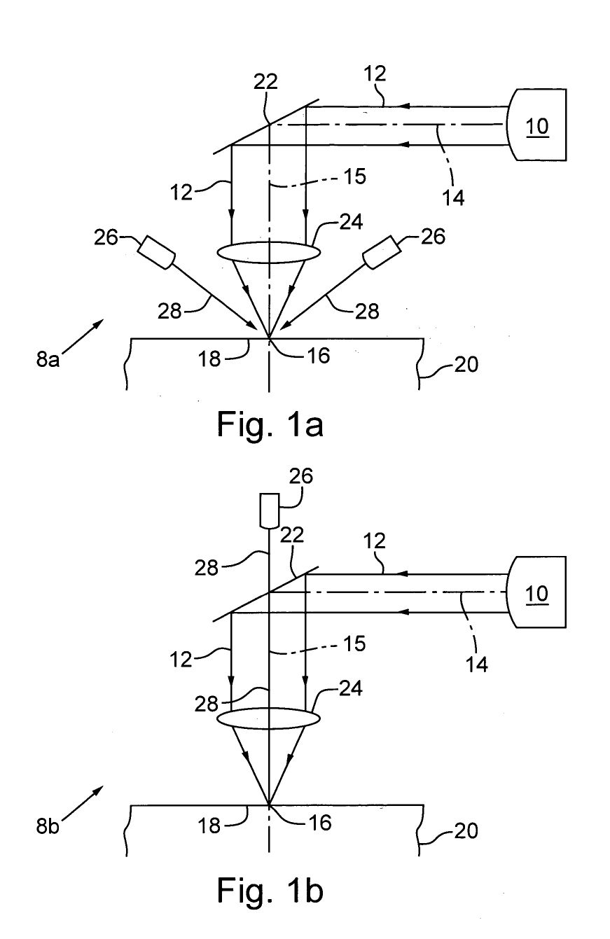

FIGS. 1a and 1b are simplified schematic diagrams of two alternative preferred embodiments of laser system 8a and 8b configured to laser process a workpiece in accordance with the method of the present invention.

With reference to FIG. 1a, a processing laser 10 emits an output processing beam 12 that propagates along a first segment 14 of an optical axis and a second segment 15 of the optical axis for incidence at a target location 16 on a target material 18 of a workpiece 20. Processing beam 12 reflects off a mirror 22 and propagates through an objective lens 24, which focuses processing beam 12 to a small spot at target location 16. Two light sources 26 function as sources of heating energy and emit heating light beams 28 that propagate along separate light paths at acute angles relative to second segment 15 of the optical axis for incidence at target location 16 on target material 18. Heating light beams 28 carry thermal energy to target material 18 to elevate its temperature and enable processing beam 12 to more efficiently laser process workpiece 20. When processing laser 10 is used to form vias in workpiece 20, a beam positioning system 30 (FIG. 3) moves processing beam 12 in a spiral, concentric circle, or trepan pattern to form a via at target location 16. Heating light source 26 or its beam delivery system (not shown) can be mounted onto beam positioning system 30 such that heating beam 28 generated by heating light source 26 moves concurrently with processing beam 12.

The heating energy carried by heating beams 28 elevates the temperature of target material 18 at target location 16 while maintaining the dimensional stability of target material 18. Processing beam 12 is characterized by a wavelength, a beam spot size, an energy per pulse, a pulse width, and a pulse repetition rate that, in combination, are appropriate for laser processing of target material 18. Elevating the temperature of target material 18 before or while directing processing beam 12 at target location 16 increases the material removal rate.

With reference to FIG. 1b, laser system 8b differs from laser system 8a in the following respects. Processing beam 12 of processing laser 10 and heating beam 28 of a single heating light source 26 propagate along second segment 15 of the optical axis and through objective lens 24 for incidence at target location 16 of target material 18. Mirror 22 preferably includes a beam combiner that facilitates transmittance of heating light beam 28 and reflects processing beam 12. One exemplary preferred beam combiner is a special coating, such as a high-reflection (HR) coating for use with the processing laser output wavelength and a high transmission (HT) coating for use with the heating source wavelength. One advantage this beam combiner offers is that it does not require that the beams be polarized, so there is no significant power loss to the light beams emitted by either the heating source or the processing laser if one or both of them are not linearly polarized. Laser system 8b arranges processing laser 10, heating light source 26, and optical component 22 so that objective lens 24 focuses processing beam 12 and heating beam 28 before they are incident on target material 18.

Because the primary purpose of heating source 26 is to elevate the temperature of target material 18, the user has greater flexibility in choosing the operational parameters of heating source 26, such as spot size and wavelength, than those of processing laser 10. As such, the type of heating source preferred typically depends on the type of processing laser 10 implemented in the laser system and the type of workpiece 20. In one preferred implementation, heating source 26 emits heating energy having a repetition rate of between about 1 Hz and about 200 Hz during its combined incidence on the target material location with processing laser output.

The present invention can be used to effect various laser processes and to laser process a variety of workpiece target materials. In a first preferred embodiment, the combined incidence of the heating energy and the processing laser output form a hole and/or a via in a single or multilayer workpiece. The processing laser output is preferably generated by one of the following processing lasers: a UV laser, an IR laser, a green laser, and a CO₂ laser. The heating energy is preferably generated by one of the following light sources: a diode laser, a diode laser array, an array of light emitting diodes, an IR solid-state laser, a UV solid-state laser, a CO₂ laser, a fiber laser, and a combination thereof.

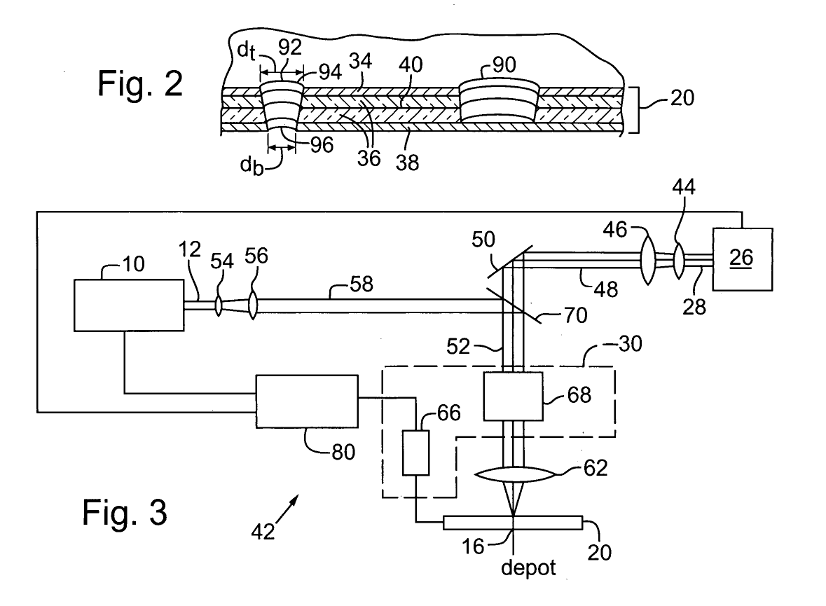

Preferred single-layer workpieces include thin copper sheets, polyimide sheets for use in electrical applications, and other metal pieces, such as aluminum, steel, and thermoplastics, for general industry and medical applications. Preferred multilayer workpieces include a multi-chip module (MCM), circuit board, or semiconductor microcircuit package. FIG. 2 shows an exemplary multilayer workpiece 20 of arbitrary type that includes layers 34, 36, 38, and 40. Layers 34 and 38 are preferably metal layers that include a metal, such as, but not limited to, aluminum, copper, gold, molybdenum, nickel, palladium, platinum, silver, titanium, tungsten, a metal nitride, or a combination thereof. Metal layers 34 and 38 preferably have thicknesses that are between about 9 μm and about 36 μm, but they may be thinner than 9 μm or as thick as 72 μm.

Layers 36 preferably include a standard organic dielectric material such as benzocyclobutane (BCB), bismaleimide triazine (BT), cardboard, a cyanate ester, an epoxy, a phenolic, a polyimide, polytetrafluorethylene (PTFE), a polymer alloy, or a combination thereof. Each organic dielectric layer 36 is typically thicker than metal layers 34 and 38. The preferred thickness of organic dielectric layer 36 is between about 30 μm and about 400 μm, but organic dielectric layer 36 may be placed in a stack having a thickness as great as 1.6 mm.

Organic dielectric layer 36 may include a thin reinforcement component layer 40. Reinforcement component layer 40 may include fiber matte or dispersed particles of, for example, aramid fibers, ceramics, or glass that have been woven or dispersed into organic dielectric layer 36. Reinforcement component layer 40 is typically much thinner than organic dielectric layer 36 and may have a thickness that is between about 1 μm and about 10 μm. Skilled persons will appreciate that reinforcement material may also be introduced as a powder into organic dielectric layer 36. Reinforcement component layer 40 including this powdery reinforcement material may be noncontiguous and nonuniform.

Skilled persons will appreciate that layers 34, 36, 38, and 40 may be internally noncontiguous, nonuniform, and nonlevel. Stacks having several layers of metal, organic dielectric, and reinforcement component materials may have a total thickness that is greater than 2 mm. Although the arbitrary workpiece 20 shown as an example in FIG. 2 has five layers, the present invention can be practiced on a workpiece having any desired number of layers, including a single-layer substrate.

Processing laser 10 may be a UV laser, an IR laser, a green laser, or a CO₂ laser. A preferred processing laser output has a pulse energy that is between about 0.01 μJ and about 1 J. A preferred UV processing laser is a Q-switched UV DPSS laser including a solid-state lasant such as Nd:YAG, Nd:YLF, Nd:YAP, or Nd:YVO4, or a YAG crystal doped with ytterbium, holmium, or erbium. The UV laser preferably provides harmonically generated UV laser output at a wavelength such as 355 nm (frequency tripled Nd:YAG), 266 nm (frequency quadrupled Nd:YAG), or 213 nm (frequency quintupled Nd:YAG). An exemplary commercially available UV DPSS laser is the Model LWE Q302 (355 nm) manufactured by Lightwave Electronics of Mountain View, Calif.

A preferred CO₂ processing laser 22 is a pulsed CO₂ laser operating at a wavelength of between about 9 μm and about 11 μm. An exemplary commercially available pulsed CO₂ laser is the Model Q3000 Q-switched laser (9.3 μm) manufactured by Coherent-DEOS of Bloomfield, Conn. Because CO₂ lasers are unable to effectively drill vias through metal layers 34 and 38, multilayer workpieces 20 drilled with CO₂ processing lasers either lack metal layers 34 and 38 or are prepared such that target location 16 has been pre-drilled with a UV laser or pre-etched using another process such as, for example, chemical etching, to expose dielectric layer 36.

In a first preferred implementation of the first embodiment, processing laser 10 is the above-described UV DPSS laser used to effect via formation and heating source 26 is a continuous wave (CW) or quasi-CW diode laser including a laser power modulator or a diode-driving current modulator. The diode laser is preferably a single or multiple diode laser operating at a wavelength of between about 600 nm and about 1600 nm and a power level of between about 0.01 W and about 1000 W, more preferably between about 20 W and about 100 W. The CW diode laser preferably emits a laser output having a wavelength that is between about 780 nm and about 950 nm. One commercially available CW diode laser is the FC series CW diode laser with fiber coupling, a laser wavelength near 808 nm, and an output power of between about 15 W to about 30 W manufactured by Spectra-Physics of Mountain View, Calif. Another preferred heating source 26 is an array of light emitting diodes with fiber coupling, a laser wavelength of about 808 nm, and an output power of between about 100 W and about 1000 W. An exemplary commercially available array of light emitting diodes is manufactured by Nuvonyx, Inc. of Bridgeton, Mo. Another preferred heating source 26 is the CW or pulsed Nd:YAG laser operating at a wavelength of 1064 nm or its second harmonic at 532 nm. A number of low-cost CW or quasi-CW lasers are readily available. Because most of the optical elements used to propagate or focus the UV processing laser beam are appropriate for wavelengths ranging from the visible to the near infrared spectrum, the wavelength of the heating source need not be in the UV spectrum.

In a second preferred implementation of the first embodiment, processing laser 10 is the above-described pulsed CO₂ laser having a wavelength between about 9.2 microns and about 10.6 microns and heating source 26 is a CW CO₂ laser, a pulsed CO₂ laser, or a laser power modulator (where the laser system is configured as shown in FIG. 1b). An exemplary commercially available CO₂ laser is a 75 W or 150 W Diamond series laser manufactured by Coherent, Inc. of Santa Clara, Calif. When using a CO₂ laser as processing laser 10, the optical elements used to propagate or focus the CO₂ laser output are not significantly transparent at wavelengths from the visible to near infrared spectrum. Thus the wavelength of the heating energy emitted by heating source 26 is preferably between about 2 microns and about 10.6 microns, and the output power is preferably between about 10 W and about 200 W.

In a third preferred implementation of the first embodiment of the present invention, processing laser 10 is a pulsed CO₂ laser having a wavelength between about 9.2 microns and about 10.6 microns, and heating source 26 is a solid-state laser, a fiber laser, a diode laser, or a combination thereof. The wavelength of the heating energy emitted by heating source 26 is preferably between about 0.7 micron and about 3.0 microns, and the output power is preferably between about 10 W and about 1000 W. As stated above, an exemplary commercially available pulsed CO₂ laser for use in this implementation is the Model Q3000 (9.3 μm) Q-switched laser manufactured by Coherent-DEOS of Bloomfield, Conn. Exemplary heating sources include an FC series CW diode laser having a fiber coupling, a laser wavelength of about 808 nm, and an output power of between about 15 W and about 30 W. An exemplary commercially available FC series CW diode laser is manufactured by Spectra-Physics of Mountain View, Calif. This CW diode laser can be modulated to operate in a pulsed mode and can be synchronized with processing laser 10.

In a fourth preferred implementation of the first embodiment, processing laser 10 is a DPSS laser whose processing laser output has a wavelength in one of the IR spectrum, the green spectrum, and the UV spectrum such that the wavelength is less than 2.1 microns. An exemplary preferred heating source is the above-mentioned FC diode laser having a fiber coupling, a laser wavelength of about 808 nm, and an output power between about 15 W and about 30 W. An exemplary commercially available UV DPSS laser is mentioned above. An exemplary commercially available DPSS green laser is a Model Q202 laser with 20 W of power delivered at a repetition rate of 40 kHz manufactured by LightWave Electronics of Mountain View, Calif.

Skilled persons will appreciate that other solid-state lasants or CO₂ lasers operating at varying wavelengths may be used in the laser system of the present invention. Various types of laser cavity arrangement, harmonic generation of the solid state laser, Q-switch operation for both the solid-state laser and the CO₂ laser, pumping schemes, and pulse generation methods for the CO₂ laser are well known to those skilled in the art.

As shown in FIG. 2, the vias formed using the laser system and method of the present invention may be blind vias 90 or through-hole vias 92. Through-hole via 92 extends from a top surface 94 to a bottom surface 96 of multilayer workpiece 20 and penetrates all of its layers. In contrast, blind via 90 does not penetrate all layers of multilayer workpiece 20.

In a second preferred embodiment of the present invention, the combined incidence of the heating energy and the processing laser output dice a semiconductor wafer. While skilled persons will appreciate that various solid-state lasants or IR lasers operating at varying wavelengths may be used in the laser system of the present invention to effect wafer dicing, the processing laser output is preferably generated by one of the following processing lasers: a UV laser, a green laser, and an IR laser. The laser operational parameters, such as pulse width and pulse repetition rate, will vary dependent upon which of these lasers is implemented. The heating energy is preferably generated by at least one of the following light sources: a diode laser, a diode laser array, a solid-state laser, a fiber laser, an array of light emitting diodes, or a combination thereof. Preferred workpieces for dicing include silicon wafers, other silicon-based materials including silicon carbide and silicon nitride, and compounds in the III-V and II-VI groups, such as gallium arsenide.

The method and laser system of the second preferred embodiment of the present invention enable the use of less of the processing laser output power to heat the target material and thereby make available more of the processing laser output power to dice the target material. Thus the method and laser system provide an increase in target material removal efficiency and a consequent increase in workpiece throughput.

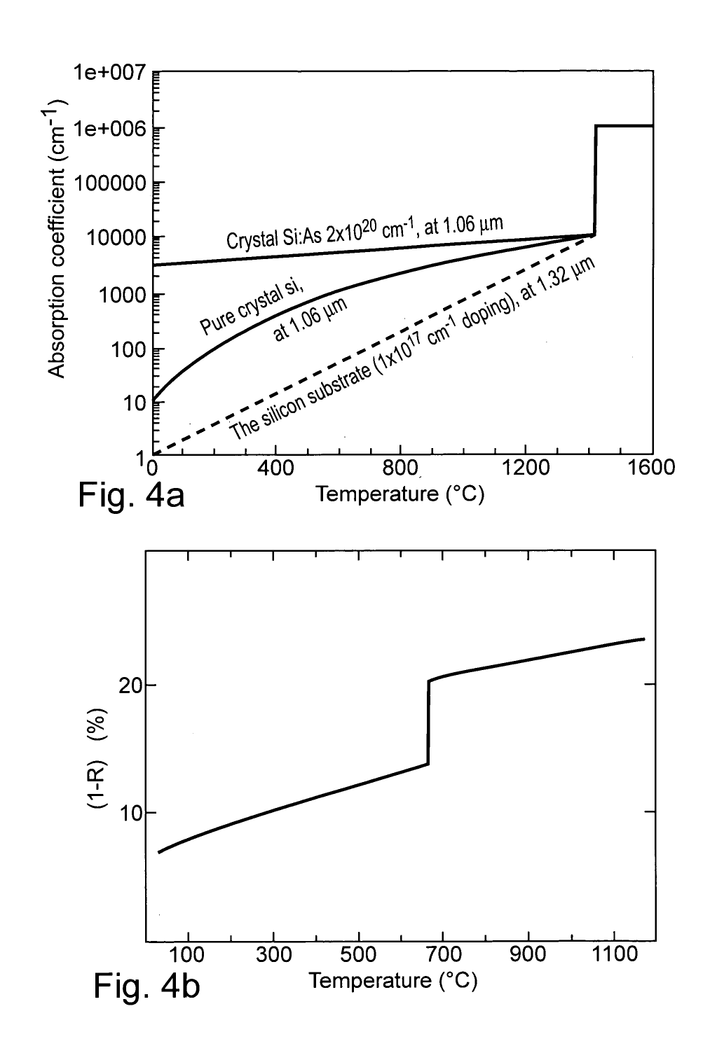

One advantage of the use of the method of the present invention to effect wafer dicing is that less debris is generated. For example, when using an IR laser having a short pulse width such as a mode-locked IR laser having a pulse width of between about 0.01 ps and about 1 ns, less re-deposited debris is generated. This is so because elevation of the temperature of the target location increases the absorption coefficient of the target material (see, e.g., FIGS. 4a and 4b, which graphically show the increased absorption coefficients of silicon and aluminum, respectively, at increased temperature), thereby facilitating the use of a processing laser having shorter pulse width and lower per pulse energy. The use of this type of laser results in a higher speed at which the removed material exits the workpiece and a lower volume of silicon wafer material removal per laser pulse, both of which result in less large-size debris creation. Limiting the amount of large-size debris created during laser processing improves the quality of the street or kerf formed by laser dicing because the debris often re-deposits itself onto the wafer, resulting in poor street or kerf quality.

In a first preferred implementation of the second embodiment of the present invention, the processing laser is a mode-locked laser generating a processing laser output having a wavelength between about 200 nm and about 1600 nm, and the heating energy is generated by at least one of the following light sources: a diode laser, a diode laser array, and a fiber laser. More specifically, the processing laser is preferably a mode-locked IR laser including optional following pulse picking and amplification and emitting a light beam having a wavelength equal to or less than about 1064 nm, a pulse width of between about 0.01 picosecond and about 1000 picoseconds, and an average laser power of between about 1 W and about 50 W at a pulse repetition rate of between about 1 kHz and about 150 MHz. An exemplary commercially available mode-locked IR laser is a Staccato laser manufactured by Lumera Laser of Chemnitz, Germany. The currently available IR power for this laser is about 20 W for a repetition rate of between about 15 kHz and about 50 kHz and a pulse width of about 10 ps. Another preferred mode-locked IR laser without following pulse picking and amplification is a Picolas series laser manufactured by Alphalas of Goettingen, Germany. This laser delivers power at a wavelength of 1064 nm, a repetition rate of 100 MHz, and a pulse width of 10 ps. The preferred heating energy source is a diode laser emitting heating energy having a wavelength that is between about 0.7 micron and about 2.2 microns.

Because the wavelength of the mode-locked IR laser and the heating source differ, a beam combiner is preferably used in connection with this preferred implementation of the second embodiment of the present invention. One exemplary preferred beam combiner is a special coating, such as HR at the mode-locked laser wavelength and HT at the heating source wavelength. One advantage that this beam combiner offers is that it does not require that the beams be polarized, so there is no significant power loss to the output emitted by either the heating source or the mode-locked IR laser where either both or one of them emits non-polarized radiation.

In another preferred implementation of the second embodiment of the present invention, the processing laser is a DPSS UV laser, a DPSS IR laser, or a green laser. The preferred heating source is the above-described diode laser.

FIG. 3 shows a preferred laser processing system 42 of the present invention in which heating source 26 emits heating beam 28 that propagates through a series of beam expanders 44 and 46 positioned along a light propagation path 48. Beam folding optics 50 reflect heating beam 28 for propagation in a direction to co-axially join and form a combined output 52 with processing beam 12 emitted by processing laser 10. Processing beam 12 emitted by processing laser 10 is converted to expanded collimated pulses by a variety of well-known optical devices, including beam expander or up-collimator lens components 54 and 56 (with, for example, a 2× beam expansion factor) positioned along a beam path 58. The combined output 52 is then controlled by beam positioning system 30 and focused by a focusing lens 62 to impinge a small area at target location 16 of workpiece 20.

Skilled persons will appreciate that different beam expansion factors can be used for both processing beam 12 and heating beam 28. Processing beam 12 and heating beam 28 preferably have the same beam spot sizes at target location 16. A preferred spot size is between about 1 micron and about 200 microns. Processing beam 12 and heating beam 28 may also have differing spot sizes. For example, the heating beam spot size may be between about 50% and about 1000% of the processing beam spot size.

A preferred beam positioning system 30 includes a translation stage positioner 66 and a fast positioner 68. Translation stage positioner 66 preferably includes at least two platforms or stages that support the workpiece and permit quick movement of workpiece 20 in a “step and repeat” manner relative to the position of the beam spot. In an alternative preferred embodiment (not shown), translation stage positioner 66 is a split-axis system in which a Y-stage supports and moves workpiece 20, an X-stage supports and moves fast positioner 68 and an objective lens, the Z dimension between the X and Y stages is adjustable. Fast positioner 68 may, for example, include a pair of galvanometer mirrors that can effect unique or duplicative processing operations based on provided test or design data. These positioners can be moved independently or coordinated to move together in response to panelized or unpanelized data. An exemplary preferred beam positioning system 30 is described in U.S. Pat. No. 5,751,585 of Cutler et al.

A laser controller 80 preferably directs the movement of beam positioning system 30 and preferably synchronizes the firing of processing laser 10 to the motion of the components of beam positioning system 30, as is described in U.S. Pat. No. 5,453,594 of Konecny. Synchronization of heating source 26 with the firing of processing laser 10 can also be effected by laser controller 80. For example, whenever processing laser 10 is fired at a target location, heating source 26 may be turned on in either a CW or pulse setting to its predetermined power to heat target location 16 before or until the firing of processing laser 10 at target location 16 is complete and beam positioning system 30 moves to the next target location 16. The predetermined power of heating source 26 may be modulated between about 50% and about 100% of the peak power of heating source 26.

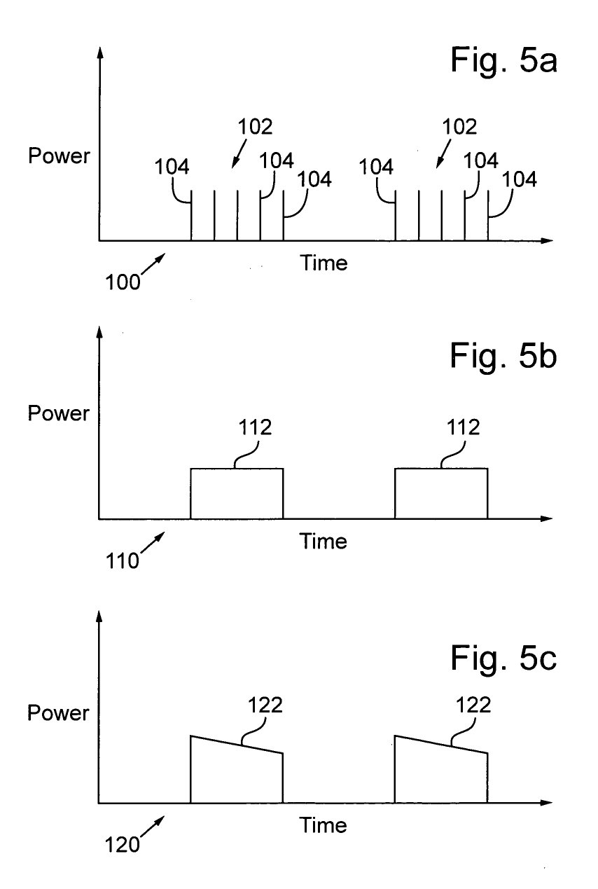

FIGS. 5a, 5b, and 5c show examples of laser output power waveforms of processing beam 12 (FIG. 5a) and heating beam 28 (FIGS. 5b and 5c).

With reference to FIG. 5a, laser output waveform 100 is a train of sets 102 of five narrow pulses 104 of processing beam 12. Each pulse 104 in a set 102 effects, for example, depthwise cutting of target material 18 in the formation of a via or scan dicing of a street or kerf. A second set 102 of pulses 104 effects depthwise removal of target material 18 to form a different via or to scan dice a different street or kerf. The number of pulses 104 and the time between adjacent pulses 104 in a set 102 are selected based on the target material and the type of via, street, or kerf being formed. The time between adjacent pulse sets 102 is determined by how quickly beam positioning system 30 moves laser processing beam 12 from one target location 16 to another target location 16, such as from via to via or from the ending point of one street or kerf formed by wafer dicing to the starting point of a consequent street or kerf formed by wafer dicing.

With reference to FIG. 5b, heating energy output waveform 110 is a train of constant power quasi-CW waveforms 112 of heating beam 28. Quasi-CW waveform 112 is timed for coincidence with and spans the time from the beginning of the first pulse 104 to the end of the fifth pulse 104 of pulse set 102. The quasi-CW waveform can end before the end of the fifth pulse 104 of pulse set 102.

The processing period include (1) a processing laser output period during which processing beam 12 is incident on target material 18 and (2) a heating energy period during which heating light beam 28 is incident on target material 18. The heating energy period is preferably between about 50% and about 100% of the processing laser output period.

With reference to FIG. 5c, heating energy output waveform 120 is a train of decreasing power quasi-CW waveforms 122 of heating beam 28. Heating energy output waveform 120 differs from heating energy output waveform 110 in that each of quasi-CW waveforms 122 decreases in power during a processing period. Heating energy output waveform 110 can also be a series of pulses (not shown) whose pulse width and repetition rate are based on the system and workpiece requirements.

One exemplary commercially available UV laser system that contains many of the above-described system components is a Model 5310 laser system, or others in its series, manufactured by Electro Scientific Industries, Inc. of Portland, Oreg. An exemplary commercially available CO₂ laser system that contains many of the above-described system components employs a Model Q 3000 CO₂ laser (9.3 μm) in a Model 5385 laser system, or others in its series. An exemplary commercially available laser dicing system that contains many of the above-described system components is a Model 4410 laser system, or others in its series.

Skilled persons will appreciate that for different single or multilayer workpieces composed of different materials, varying laser parameters, such as pulse repetition rate, energy per pulse, and beam spot size, can be programmed during different processing stages to effect optimal via formation throughput and via quality. See, e.g., U.S. Pat. No. 5,841,099 of Owen et al. and U.S. Pat. No. 6,407,363 of Dunsky et al., both of which are assigned to the assignee of the present patent application. Those skilled in the art will also appreciate that the operational parameters of the heating source, such as its power, energy distribution profile, and spot size, can be kept constant or changed during various stages of laser processing.

It will be obvious to those having skill in the art that many changes may be made to the details of the above-described embodiments of this invention without departing from the underlying principles thereof. The scope of the present invention should, therefore, be determined only by the following claims.

1. A method of using a laser output to rapidly remove target material from a target material location of a workpiece, the laser output removing a portion of the target material at a material removal rate, and the target material characterized by a temperature and a dimensional stability property, comprising:
applying heating energy in the form of a light beam to the target material location to elevate its temperature while substantially maintaining the dimensional stability property of the target material; and
directing for incidence on the target material location a processing laser output characterized by a wavelength, a beam spot size, an energy per pulse, a pulse width, and a pulse repetition rate that, in combination, are appropriate to effect removal of the target material, the combined incidence of the processing laser output and the heating energy on the target material location enabling the processing laser output to remove a portion of the target material at a material removal rate that is higher than a material removal rate achievable in the absence of the heating energy.

2. The method of claim 1, in which the method involves forming a via in the workpiece, the processing laser output is generated by a processing laser that is selected from a group consisting essentially of an ultraviolet laser, an IR laser, a green laser, and a CO₂ laser, and the heating energy is generated by a light source that is selected from a group consisting essentially of a diode laser, a diode laser array, an array of light emitting diodes, a fiber laser, an IR laser, an ultraviolet laser, a CO₂ laser, and a combination thereof.

3. The method of claim 2, in which the via is one of a blind via or a through-hole via.

4. The method of claim 2, in which the processing laser output is generated by a processing laser that is a diode-pumped, Q-switched solid-state laser, the processing laser output has a wavelength in the IR spectrum such that the wavelength is less than 2.1 microns, and the heating energy has a wavelength of less than 2.2 microns.

5. The method of claim 2, in which the processing laser output is generated by a processing laser that is a diode-pumped, Q-switched solid-state laser, the processing laser output has a harmonic output in one of the green spectrum and the ultraviolet spectrum such that the wavelength is less than 0.6 micron, and the heating energy has a wavelength of less than 2.2 microns.

6. The method of claim 2, in which the processing laser is selected from a group consisting essentially of a pulsed CO₂ laser and a Q-switched CO₂ laser, the processing laser output has a wavelength between about 9.2 microns and about 10.6 microns, the light source is a CO₂ laser, and the heating energy has a wavelength that is between about 9.2 microns and about 10.6 microns.

7. The method of claim 2, in which the processing laser is selected from a group consisting essentially of a pulsed CO₂ laser and a Q-switched CO₂ laser, the processing laser output has a wavelength that is between about 9.2 microns and about 10.6 microns, the heating energy has a wavelength that is between about 0.7 micron and about 3 microns, and the light source is selected from a group consisting essentially of a solid-state laser, a fiber laser, a diode laser, and a combination thereof.

8. The method of claim 2, in which the workpiece is a thin copper sheet, the processing laser output is generated by a laser selected from a group consisting essentially of a pulsed CO₂ laser and a Q-switched CO₂ laser, and the heating energy has a wavelength that is shorter than 2.2 microns.

9. The method of claim 1, in which the workpiece is a semiconductor wafer, the method involves dicing the semiconductor wafer, the processing laser output is generated by a processing laser that is selected from a group consisting essentially of an ultraviolet laser, a green laser, and an IR laser, and the heating energy is generated by a light source that is selected from a group consisting essentially of a diode laser, a diode laser array, a solid-state laser, a fiber laser, an array of light emitting diodes, and a combination thereof.

10. The method of claim 9, in which the processing laser is a mode-locked laser, the processing laser output has a wavelength that is between about 200 nm and about 1600 nm, the heating energy has a wavelength that is between about 0.7 micron and about 2.2 microns, and the light source is selected from a group consisting essentially of a diode laser, a diode laser array, a fiber laser, and a combination thereof.

11. The method of claim 1, in which the workpiece includes multiple, different target material locations and in which the processing laser output removes from the different target material locations target material whose temperature is elevated by the heating energy, thereby removing target material at the different target material locations at a workpiece throughput rate that is higher than a workpiece throughout rate achievable in the absence of the heating energy.

12. The method of claim 1, in which the light beam, when illuminating the target material, has a light beam spot size and the processing laser output, when incident on the target material, has a processing laser output spot size, the light beam spot size being between about 50% and about 1000% of the processing laser output spot size.

13. The method of claim 1, in which the light beam has a light beam wavelength and the processing laser output has a processing laser output wavelength, and further comprising a light beam combining optical element that combines the light beam and the processing laser output and processes the light beam before it illuminates the target material and processes the processing laser output before it is incident on the target material, the light beam wavelength and the processing laser output wavelength defining a wavelength range that is within an operating wavelength range of the beam combining optical element.

14. The method of claim 1, in which the workpiece is a multilayer material.

15. The method of claim 1, in which the processing laser output and the heating energy are directed to the target material location by multiple, separate beam steering and focusing optics.

16. The method of claim 1, in which the processing laser output has a spot size that is between about 1 micron and about 200 microns.

17. The method of claim 1, in which the processing laser output has a pulse repetition rate that is between about 1 Hz and about 150 MHz.

18. The method of claim 1, in which the processing laser output has a pulse energy that is between about 0.01 μJ and about 1 J.

19. The method of claim 1, in which the heating energy comprises a continuous wave of energy during its combined incidence with the processing laser output on the target material location.

20. The method of claim 1, in which the processing laser output and heating energy are applied to the target material location for, respectively, a processing laser output period and a heating energy period, and in which the heating energy period is between about 50% and about 100% of the processing laser output period.

21. The method of claim 1, in which the heating energy comprises a series of pulses having a repetition rate of between about 1 Hz and about 200 kHz during its combined incidence on the target material location with processing laser output.

22. The method of claim 1, in which the heating energy has an average power of between about 0.01 W and about 1000 W.

23. The method of claim 1, in which the heating energy has a heating energy power level that is modulated between about 50% and about 100% of a peak power level during the combined incidence of the processing laser output and the heating energy on the target material location.
